(19) United States
(12) Patent Application Publication
(10) Pub. No.: US 2025/0227628 A1
(43) Pub. Date: Jul. 10, 2025

(54) TRANSMISSION CONFIGURATION INDICATION-SPECIFIC VIRTUAL POWER HEADROOM REPORTING

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/853,554

(22) PCT Filed: May 17, 2022
(86) PCT No.: PCT/CN2022/093264

§ 371 Date: Oct. 2, 2024

(51) Int. Cl. H04W 52/36; H04L 5/00; H04W 52/14

(52) U.S. Cl. CPC H04W 52/365; H04L 5/0051; H04W 52/146; H04W 52/367

(57) ABSTRACT

Methods, systems, and devices for wireless communications are described. A user equipment (UE) may receive a message indicating first and second sets of power control parameters associated with a first transmission reception point (TRP) and a second TRP. The UE may generate a first power headroom report (PHR) for a first uplink transmission associated with a first reference signal resource index using the first set of parameters, the first reference signal an actual transmission or a reference (e.g., virtual) transmission, and a second PHR for a reference uplink transmission associated with a second reference signal resource index using the second set of parameters. The second PHR may be a virtual PHR because of the reference uplink transmission, and the first PHR may be a virtual PHR if the first uplink transmission is a reference uplink transmission. The UE may transmit a message including the first and second PHRs.

### CROSS REFERENCE

The present Application is a 371 national phase filing of International PCT Application No. PCT/CN2022/093264 by YUAN et al., entitled “TRANSMISSION CONFIGURATION INDICATION-SPECIFIC VIRTUAL POWER HEADROOM REPORTING,” filed May 17, 2022, which is assigned to the assignee hereof, and which is expressly incorporated by reference in its entirety herein.

### FIELD OF TECHNOLOGY

The present disclosure relates to wireless communications, including transmission configuration indication (TCI)-specific virtual power headroom reporting (PHR).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may communicate with a network entity via one or more transmission reception points (TRPs). In some examples, techniques for calculating a power headroom associated with a TRP may be improved.

### SUMMARY

The described techniques relate to improved methods, systems, devices, and apparatuses that support transmission configuration indication (TCI)-specific virtual power headroom reporting (PHR). For example, the described techniques provide for a user equipment (UE) performing virtual PHR in a multiple transmission reception point (mTRP) system. In some examples, a network entity may configure a UE with first and second sets of power control parameters associated with a first TRP and a second TRP, respectively. Each set of power control parameters may include a path loss reference signal (PLRS) parameter, a nominal power parameter, an alpha value parameter, a close loop index parameter, a power management maximum power reduction (P-MPR) parameter, or a combination thereof. In some cases, at least the second set of power control parameters may be associated with virtual PHR. The UE may transmit a message including a first PHR generated by the UE for a first uplink transmission (e.g., a scheduled physical uplink shared channel (PUSCH) transmission or non-scheduled PUSCH transmission) using the first set of power control parameters. In addition, the message may include a second PHR generated by the UE for a reference uplink transmission (e.g., a non-scheduled PUSCH transmission) using the second set of power control parameters. Accordingly, the UE may transmit two PHRs to a network entity based on the UE being in communication with two TRPs with separate sets of uplink control parameters.

In some examples, the first uplink transmission and the reference uplink transmission may be associated with respective TCI states, which the network entity may configure in a TCI configuration. As such, the first and second sets of power control parameters may be associated with respective TCI states. In addition, the network entity may indicate the first and second sets of power control parameters, and their association with a TRP and a corresponding reference signal resource index, in an uplink bandwidth part (BWP) configuration or a serving cell configuration.

A method for wireless communication at a UE is described. The method may include receiving a first message indicating a first set of power control parameters associated with a first transmission reception point and a second set of power control parameters associated with a second transmission reception point, where at least the second set of power control parameters are associated with virtual PHR and transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

An apparatus for wireless communication at a UE is described. The apparatus may include a processor, memory coupled with the processor, and instructions stored in the memory. The instructions may be executable by the processor to cause the apparatus to receive a first message indicating a first set of power control parameters associated with a first transmission reception point and a second set of power control parameters associated with a second transmission reception point, where at least the second set of power control parameters are associated with virtual PHR and transmit a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

Another apparatus for wireless communication at a UE is described. The apparatus may include means for receiving a first message indicating a first set of power control parameters associated with a first transmission reception point and a second set of power control parameters associated with a second transmission reception point, where at least the second set of power control parameters are associated with virtual PHR and means for transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

A non-transitory computer-readable medium storing code for wireless communication at a UE is described. The code may include instructions executable by a processor to receive a first message indicating a first set of power control parameters associated with a first transmission reception point and a second set of power control parameters associated with a second transmission reception point, where at least the second set of power control parameters are associated with virtual PHR and transmit a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

In some examples of the method, apparatuses, and non-transitory computer-readable medium described herein, receiving the first message may include operations, features, means, or instructions for receiving the first message indicating a TCI configuration identifying that the first uplink transmission may be associated with a first TCI state and the reference uplink transmission may be associated with a second TCI state.

In some examples of the method, apparatuses, and non-transitory computer-readable medium described herein, receiving the first message may include operations, features, means, or instructions for receiving the first message indicating an uplink BWP configuration identifying that the first uplink transmission may be associated with the first set of power control parameters and that the reference uplink transmission may be associated with the second set of power control parameters.

In some examples of the method, apparatuses, and non-transitory computer-readable medium described herein, receiving the first message may include operations, features, means, or instructions for receiving the first message indicating a serving cell configuration identifying that the first uplink transmission may be associated with the first set of power control parameters and that the reference uplink transmission may be associated with the second set of power control parameters.

In some examples of the method, apparatuses, and non-transitory computer-readable medium described herein, the first set of power control parameters and the second set of power control parameters include a pathloss reference signal parameter.

In some examples of the method, apparatuses, and non-transitory computer-readable medium described herein, the first set of power control parameters and the second set of power control parameters further include a nominal power parameter, an alpha value parameter, and a close loop index parameter.

In some examples of the method, apparatuses, and non-transitory computer-readable medium described herein, the first set of power control parameters and the second set of power control parameters further include a power management maximum power reduction parameter.

In some examples of the method, apparatuses, and non-transitory computer-readable medium described herein, the first uplink transmission includes an actual uplink transmission.

In some examples of the method, apparatuses, and non-transitory computer-readable medium described herein, the first uplink transmission includes a reference uplink transmission.

In some examples of the method, apparatuses, and non-transitory computer-readable medium described herein, the first PHR and the second PHR may be a first type of PHR that indicates a difference between a maximum transmit power of the UE and an estimated power of an uplink transmission.

In some examples of the method, apparatuses, and non-transitory computer-readable medium described herein, receiving the first message may include operations, features, means, or instructions for receiving the first message according to a single frequency network configuration.

A method for wireless communication at a network node is described. The method may include transmitting a first message indicating a first set of power control parameters associated with a first transmission reception point and a second set of power control parameters associated with a second transmission reception point, where at least the second set of power control parameters are associated with virtual PHR and receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

An apparatus for wireless communication at a network node is described. The apparatus may include a processor, memory coupled with the processor, and instructions stored in the memory. The instructions may be executable by the processor to cause the apparatus to transmit a first message indicating a first set of power control parameters associated with a first transmission reception point and a second set of power control parameters associated with a second transmission reception point, where at least the second set of power control parameters are associated with virtual PHR and receive a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

Another apparatus for wireless communication at a network node is described. The apparatus may include means for transmitting a first message indicating a first set of power control parameters associated with a first transmission reception point and a second set of power control parameters associated with a second transmission reception point, where at least the second set of power control parameters are associated with virtual PHR and means for receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

A non-transitory computer-readable medium storing code for wireless communication at a network node is described. The code may include instructions executable by a processor to transmit a first message indicating a first set of power control parameters associated with a first transmission reception point and a second set of power control parameters associated with a second transmission reception point, where at least the second set of power control parameters are associated with virtual PHR and receive a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

In some examples of the method, apparatuses, and non-transitory computer-readable medium described herein, transmitting the first message may include operations, features, means, or instructions for transmitting the first message indicating a TCI configuration identifying that the first uplink transmission may be associated with a first TCI state and the reference uplink transmission may be associated with a second TCI state.

In some examples of the method, apparatuses, and non-transitory computer-readable medium described herein, transmitting the first message may include operations, features, means, or instructions for transmitting the first message indicating an uplink BWP configuration identifying that the first uplink transmission may be associated with the first set of power control parameters and that the reference uplink transmission may be associated with the second set of power control parameters.

In some examples of the method, apparatuses, and non-transitory computer-readable medium described herein, transmitting the first message may include operations, features, means, or instructions for transmitting the first message indicating a serving cell configuration identifying that the first uplink transmission may be associated with the first set of power control parameters and that the reference uplink transmission may be associated with the second set of power control parameters.

In some examples of the method, apparatuses, and non-transitory computer-readable medium described herein, the first set of power control parameters and the second set of power control parameters include a pathloss reference signal parameter.

In some examples of the method, apparatuses, and non-transitory computer-readable medium described herein, the first set of power control parameters and the second set of power control parameters further include a nominal power parameter, an alpha value parameter, and a close loop index parameter.

In some examples of the method, apparatuses, and non-transitory computer-readable medium described herein, the first set of power control parameters and the second set of power control parameters further include a power management maximum power reduction parameter.

In some examples of the method, apparatuses, and non-transitory computer-readable medium described herein, the first uplink transmission includes an actual uplink transmission.

In some examples of the method, apparatuses, and non-transitory computer-readable medium described herein, the first uplink transmission includes a reference uplink shared channel transmission.

In some examples of the method, apparatuses, and non-transitory computer-readable medium described herein, the first PHR and the second PHR may be a first type PHR that indicates a difference between a maximum transmit power of the UE and an estimated power of an uplink transmission.

In some examples of the method, apparatuses, and non-transitory computer-readable medium described herein, receiving the first message may include operations, features, means, or instructions for receiving the first message according to a single frequency network configuration.

### BRIEF DESCRIPTION OF THE DRAWINGS

FIG. 1 illustrates an example of a wireless communications system that supports transmission configuration indication (TCI)-specific virtual power headroom reporting (PHR) in accordance with one or more aspects of the present disclosure.

FIG. 2 illustrates an example of a network architecture that supports TCI-specific virtual PHR in accordance with one or more aspects of the present disclosure.

FIG. 3 illustrates an example of a wireless communications system that supports TCI-specific virtual PHR in accordance with one or more aspects of the present disclosure.

FIGS. 4 and 5 illustrate examples of process flows that support TCI-specific virtual PHR in accordance with one or more aspects of the present disclosure.

FIGS. 6 and 7 show block diagrams of devices that support TCI-specific virtual PHR in accordance with one or more aspects of the present disclosure.

FIG. 8 shows a block diagram of a communications manager that supports TCI-specific virtual PHR in accordance with one or more aspects of the present disclosure.

FIG. 9 shows a diagram of a system including a device that supports TCI-specific virtual PHR in accordance with one or more aspects of the present disclosure.

FIGS. 10 and 11 show block diagrams of devices that support TCI-specific virtual PHR in accordance with one or more aspects of the present disclosure.

FIG. 12 shows a block diagram of a communications manager that supports TCI-specific virtual PHR in accordance with one or more aspects of the present disclosure.

FIG. 13 shows a diagram of a system including a device that supports TCI-specific virtual PHR in accordance with one or more aspects of the present disclosure.

FIGS. 14 through 18 show flowcharts illustrating methods that support TCI-specific virtual PHR in accordance with one or more aspects of the present disclosure.

### DETAILED DESCRIPTION

A user equipment (UE) may support power headroom reporting (PHR) for multiple transmission reception point (mTRP) wireless communications. A power headroom value may indicate how much transmission power may be available for the UE to use for a scheduled transmission, and may be calculated as a difference between a maximum available transmission power and an estimated (e.g., required) transmission power for a scheduled transmission based on a set of power control parameters. If the power headroom value is positive, the UE may have enough transmit power to successfully transmit the scheduled transmission. If the power headroom value is negative, the UE may already be transmitting at or above the maximum transmission power. In some examples, the UE may generate a power headroom value for an actual uplink transmission (which may also be referred to as a scheduled uplink transmission) using a set of power control parameters, or the UE may generate a virtual power headroom value for a reference uplink transmission (which may also be referred to as a virtual uplink transmission, or a non-scheduled uplink transmission) using the set of power control parameters. For virtual PHR however, using a single set of power control parameters to generate power headroom values for multiple scheduled or non-scheduled uplink transmissions may increase latency and reduce flexibility of the power headroom calculation, particularly in a mTRP system where respective TRPs may be associated with different power control parameters.

The techniques described herein support a UE performing virtual PHR in an mTRP system. In some examples, a network entity may configure a UE with first and second sets of power control parameters associated with a first TRP and a second TRP, respectively. Each set of power control parameters may include a path loss reference signal (PLRS) parameter, a nominal power parameter, an alpha value parameter, a close loop index parameter, a power management maximum power reduction (P-MPR) parameter, or a combination thereof. In some cases, at least the second set of power control parameters may be associated with virtual PHR. The UE may transmit a message including a first PHR generated by the UE for a first uplink transmission (e.g., a scheduled or non-scheduled physical uplink shared channel (PUSCH) transmission) using the first set of power control parameters. In addition, the message may include a second PHR generated by the UE for a reference uplink transmission (e.g., a non-scheduled PUSCH transmission) using the second set of power control parameters. Accordingly, the UE may transmit two PHRs to a network entity based on the UE being in communication with two TRPs with separate sets of uplink control parameters.

In some examples, the first uplink transmission and the reference uplink transmission may be associated with respective transmission configuration indicator (TCI) states, which the network entity may configure via a TCI configuration. As such, the first and second sets of power control parameters may be associated with respective TCI states. In addition, the network entity may indicate the first and second sets of power control parameters, and their association with a TRP and a corresponding reference signal resource index, in an uplink bandwidth part (BWP) configuration or a serving cell configuration.

Aspects of the subject matter described herein may be implemented to realize one or more of the following potential improvements, among others. The techniques employed by the described communication devices may enable a UE to generate PHRs for different TRPs using one or more corresponding sets of power control parameters, which may increase flexibility and accuracy of a virtual PHR. That is, the UE may more accurately generate a PHR for one or more scheduled or non-scheduled (e.g., virtual) uplink transmissions associated with respective reference signal resource indices, which may result in reduced latency and improved communications between the network entity and the UE, among other benefits.

Aspects of the disclosure are initially described in the context of wireless communications systems. Aspects of the disclosure are then described in the context of network architectures and process flows. Aspects of the disclosure are further illustrated by and described with reference to apparatus diagrams, system diagrams, and flowcharts that relate to TCI-specific virtual PHR.

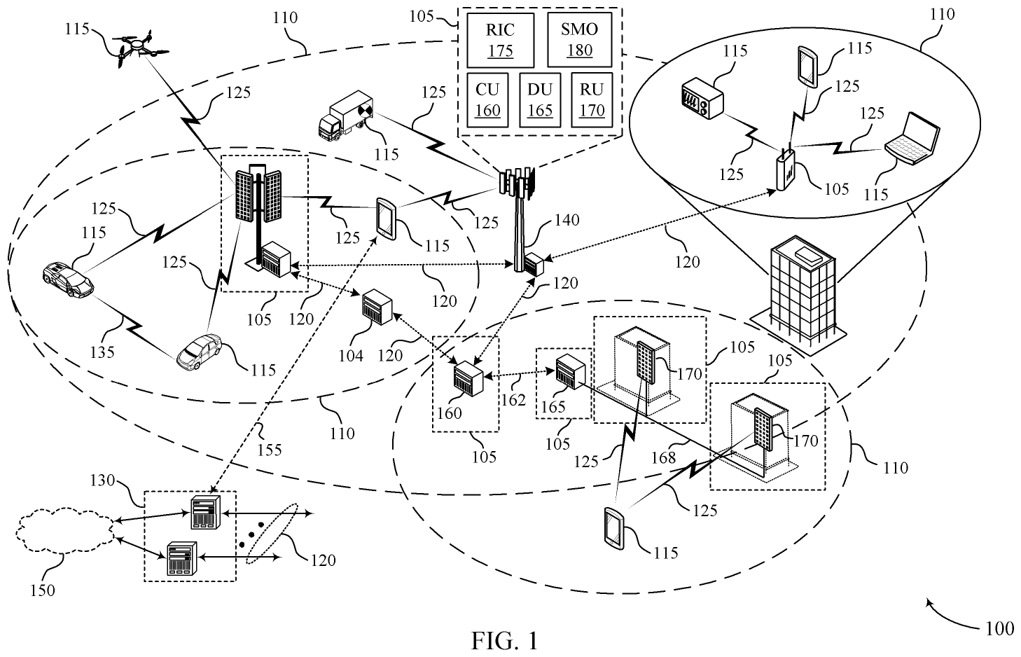

FIG. 1 illustrates an example of a wireless communications system 100 that supports TCI-specific virtual PHR in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TCI-specific virtual PHR as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

A UE 115 may support mTRP wireless communications, for example, with two or more network entities 105. The mTRP communications may be TDM-based or simultaneous transmission-based (e.g., SDM or FDM-based). In addition, the UE 115 may support PHR for mTRP operations. A PHR may indicate how much transmission power is available for the UE 115 to use for scheduled transmissions based on a maximum transmission power. In some cases, a PHR may be an example of or included in a MAC control element (MAC-CE) that indicates the headroom between a current UE transmit power and a nominal power. A network entity 105 may use the power headroom value in the PHR to estimate how much uplink bandwidth the UE 115 may use for its scheduled transmissions. In some cases, the UE 115 may determine a Type 1 PHR for an activated serving cell based on a reference uplink transmission (e.g., a PUSCH transmission). For a PUSCH transmission occasion i on an active uplink BWP b of a carrier f of a serving cell c, the UE 115 may calculate the type 1 PHR following Equation 1 below.

$$P {H}_{type 1 , b , f , c} ( i , j , {q}_{d} , l ) = {\tilde{P}}_{C M A X , f , c} ( i ) - \{ {P}_{{O}_{P U S C H} , b , f , c} ( j ) + {α}_{b . f . c} ( j ) \cdot {PL}_{b , f , c} ( {q}_{d} ) + {f}_{b , f , c} ( i , l ) \} \qquad ( 1 )$$

In Equation 1, a UE 115 may compute a maximum transmission power \tilde{P}_{CMAX,f,c}(i) based on assuming MRP=0 dB, additional MRP (A-MRP)=0 dB, P-MRP=0 dB, and ΔT_{C}=0 dB, where an MRP may represent an allowed reduction of the maximum transmission power for some physical channels (e.g., in an uplink MIMO system), and ΔT_{C} may represent a closed loop power control parameter which enables the network entity 105 to adjust the transmission power at UE 115. In addition, P_{O}_{_{pusCH}}_{,b,f,c}(j) may represent a nominal transmission power, α_{b,f,c}(j) may represent a power control factor, and P_{O}_{_{NOMINAL.PUSCH}}_{,b,f,c}(j) may represent a nominal transmission power for a PUSCH. The UE 115 may determine P_{O}_{_{PUSCH}}_{,b,f,c}(j) and α_{b,f,c}(j) using P_{O}_{_{NOMINMINAL.PUSCH}}_{,b,f,c}(j) and a parameter (e.g., p0-PUSCH-AlphaSetId=0), and the UE 115 may obtain a pathloss parameter for a reference signal with index q_{d}, PL_{b,f,c}(qd), using a pathloss parameter (e.g., pusch-PathlossReferenceRS-Id=0, and I=0. Thus, virtual PHR may be based on a non-scheduled (e.g., virtual) PUSCH transmission instead of a scheduled PUSCH transmission, such that the virtual PHR is based on some assumption of parameters related to the non-scheduled PUSCH transmission instead of indicated parameters for the scheduled PUSCH transmission. In addition, using Equation 1, the UE may use a single set of power control parameters for virtual PHR.

In some examples, the UE 115 may report two PHRs for two TRPs supported by the same serving cell (e.g., in an mTRP system). The UE 115 may use a single set of power control parameters (e.g., not specific to a TRP) to generate the two PHRs, where at least one of the PHRs may be a virtual PHR that are not TRP-specific. In addition, the UE 115 may support unified TCIs for mTRP communications, where the unified TCIs for uplink and downlink may be included with the set of power control parameters, and where different TRPs may have different unified TCIs. In some examples, the UE 115 may use a unified TCI framework for the indication of multiple downlink and uplink TCI states for mTRP communications.

Some network entities 105 may configure (e.g., via an RRC configuration) a set of power control parameters for each serving cell of a UE 115. In some cases, multiple sets of power control parameters may be configured for each serving cell of the UE 115 (e.g., in Uplink-powerControl). For example, each TCI state may be associated with a set of power control parameters. Additionally, or alternatively, the power control parameters may be configured in a serving cell configuration (e.g., ServingCellConfig). For example, the serving cell configuration may include a list of uplink power control parameters for a corresponding serving cell, where the power control parameters may be configured for a PUSCH, a physical uplink control channel (PUCCH), a sounding reference signal (SRS), or other transmission types. In addition, different TCI states (e.g., joint, or uplink TCI states) may correspond to different uplink power control parameters. Alternatively, if each TCI state lacks an association with a set of power control parameters, a corresponding uplink BWP configuration may be associated with a set of power control parameters. For example, an uplink bandwidth parameter (e.g., BWP-UplinkDedicated) may include a set of uplink control parameters.

In some examples, the UE 115 may schedule a PUSCH associated with a first reference signal resource index qd on the active uplink BWP b of the carrier f of the serving cell c in a slot n. In addition, the UE 115 may be configured with one or more PHR modes (e.g., twoPHRMode), which may include Type 1 or Type 2 PHRs. A Type 1 PHR may indicate a power headroom as a difference between a nominal, maximum transmit power of the UE 115 and an estimated transmit power for a scheduled uplink transmission per activated serving cell. A Type 2 PHR may indicate a power headroom as a difference between the nominal, maximum transmit power of the UE and the estimated power for an uplink share channel transmission or an uplink control channel transmission of a special cell.

Using the scheduled PUSCH and the PHR configuration, the UE 115 may transmit a Type 1 PHR to a network entity 105 for PUSCH repetition associated with a second reference signal resource index q_{d}. In some examples, the UE 115 may transmit the Type 1 PHR based on one or more conditions. For example, the UE 115 may transmit the type 1 PHR based on a first scheduled PUSCH transmission associated with the first reference signal resource index. In some examples, the UE 115 may transmit the Type 1 PHR for a second scheduled PUSCH transmission associated with the second reference signal resource index if the UE transmits the PUSCH transmissions associated with the second reference signal resource index in the slot n, where the first scheduled PUSCH transmission and the second scheduled PUSCH transmission may be scheduled for mTRP operations. Alternatively, the UE 115 may transmit the Type 1 PHR for a scheduled PUSCH transmission associated with the first reference signal resource index, and the UE 115 may transmit the Type 1 PHR for a reference (e.g., non-scheduled) PUSCH transmission associated with the second reference signal resource index (e.g., in an example of virtual PHR). In some cases, the UE 115 may transmit the Type 1 PHR for a reference PUSCH transmission associated with the second reference signal resource index if the UE provides the Type 1 PHR for a reference PUSCH transmission associated with the first reference signal resource index.

The wireless communications system 100 may support TCI-specific virtual PHR to improve communications between the network entity 105 and a UE 115. In some examples, a network entity 105 may configure a UE 115 with first and second sets of power control parameters associated with a first TRP and a second TRP, respectively. Each set of power control parameters may include a PLRS parameter, a nominal power parameter, an alpha value parameter, a close loop index parameter, a P-MPR parameter, or a combination thereof. In some cases, at least the second set of power control parameters may be associated with virtual PHR. The UE 115 may transmit a message including a first PHR generated by the UE 115 for a first uplink transmission (e.g., a scheduled or non-scheduled PUSCH transmission) using the first set of power control parameters. In addition, the message may include a second PHR generated by the UE 115 for a reference uplink transmission (e.g., a non-scheduled PUSCH transmission) using the second set of power control parameters. Accordingly, the UE 115 may transmit two PHRs to a network entity 105 based on the UE 115 being in communication with two TRPs with separate sets of uplink control parameters.

In some examples, the first uplink transmission and the reference uplink transmission may be associated with respective TCI states, which the network entity 105 may configure in a TCI configuration. As such, the first and second sets of power control parameters may be associated with respective TCI states. In addition, the network entity 105 may indicate the first and second sets of power control parameters, and their association with a TRP and a corresponding reference signal resource index, in an uplink BWP configuration or a serving cell configuration.

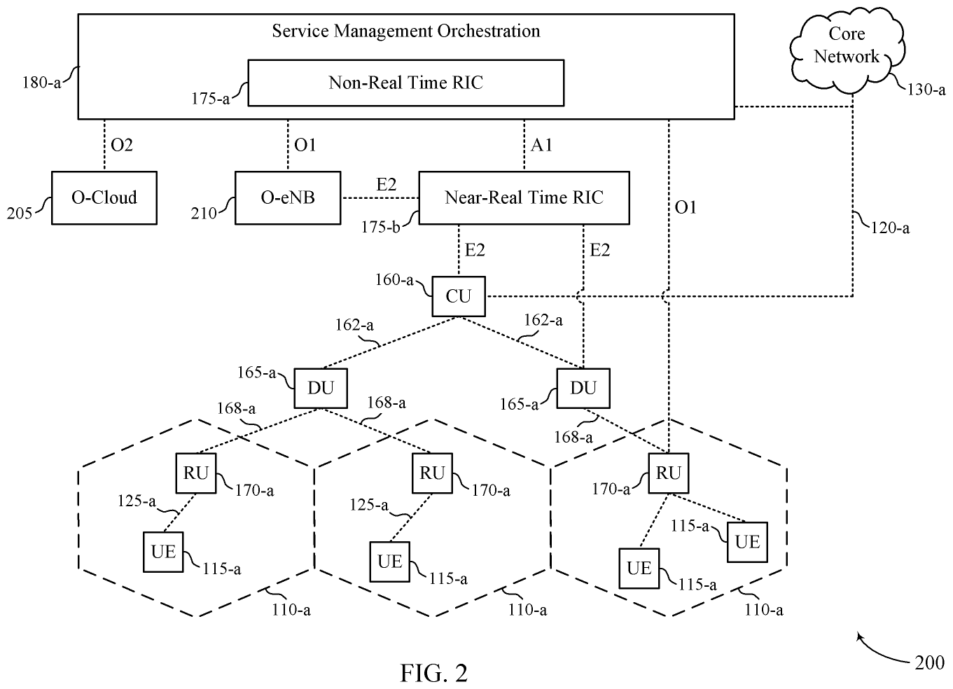

FIG. 2 illustrates an example of a network architecture 200 (e.g., a disaggregated base station architecture, a disaggregated RAN architecture) that supports TCI-specific virtual PHR in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 may support TCI-specific virtual PHR to improve communications between the network entity 105 and a UE 115-a. In some examples, a network entity 105 may configure a UE 115-a with first and second sets of power control parameters associated with a first TRP and a second TRP, respectively. Each set of power control parameters may include a PLRS parameter, a nominal power parameter, an alpha value parameter, a close loop index parameter, a P-MPR parameter, or a combination thereof. In some cases, at least the second set of power control parameters may be associated with virtual PHR. The UE 115-a may transmit a message including a first PHR generated by the UE 115-a for a first uplink transmission (e.g., a scheduled or non-scheduled PUSCH transmission) using the first set of power control parameters. In addition, the message may include a second PHR generated by the UE 115-a for a reference uplink transmission (e.g., a non-scheduled PUSCH transmission) using the second set of power control parameters. Accordingly, the UE 115-a may transmit two PHRs to a network entity 105 based on the UE 115-a being in communication with two TRPs with separate sets of uplink control parameters.

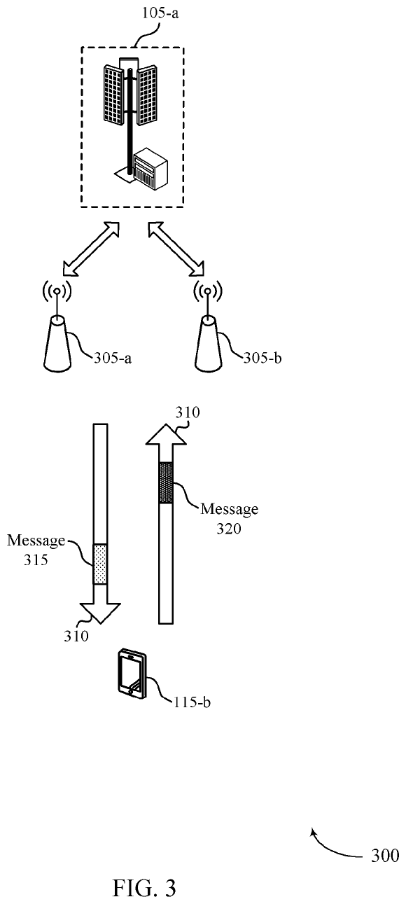

FIG. 3 illustrates an example of a wireless communications system 300 that supports TCI-specific virtual PHR in accordance with one or more aspects of the present disclosure. In some examples, the wireless communications system 300 may implement aspects of the wireless communications system 100 or may be implemented by aspects of the wireless communications system 100. For example, the wireless communications system 300 may include a UE 115-b, a network entity 105-a, and TRPs 305, which may be examples of corresponding devices described herein. In some examples, the UE 115-b may generate PHRs for one or more uplink transmissions using a first and second set of parameters that correspond to respective TRPs 305.

The network architecture 200 may support communications between the network entity 105-a and the UE 115-b. For example, the UE 115-b may operate in a multiple TRP mode with a first TRP 305-a and a second TRP 305-b. In some cases, the first TRP 305-a and the second TRP 305-b may be located at a same network entity 105-a. In some cases, the first TRP 305-a and the second TRP 305-b may be located at different network entities 105.

In some examples, the UE 115-b may perform simultaneous communication with the first TRP 305-a and the second TRP 305-b over respective communication links 310, which may be examples of communication links 125 as described herein with reference to FIG. 1. The communication links 310 may include bi-directional links that enable both uplink and downlink communication. For example, the UE 115-b may transmit uplink signals, such as uplink control signals or uplink data signals, to the first TRP 305-a using a respective communication link 310 and the first TRP 305-a may transmit downlink transmissions, such as downlink control signals or downlink data signals, to the UE 115-b using a respective communication link 310. The UE 115-b may transmit uplink signals, such as uplink control signals or uplink data signals, to the second TRP 305-b using the respective communication link 310, and the second TRP 305-b may transmit downlink transmissions, such as downlink control signals or downlink data signals, to the UE 115-b using the respective communication link 310. In some examples, different TRPs 305 (e.g., the first TRP 305-a and the second TRP 305-b) may have different TRP identifiers (IDs). In some examples, different TRPs may be identified through an association with other IDs, such as a CORESET pool index, close loop index, TCI ID, TCI group ID, or an SRS resource set ID. In some cases, the UE 115-b may operate according to a single frequency network (SFN) configuration such that the UE 115-b may receive the same content from each TRP 305 at a same frequency in a synchronized manner.

To support generating multiple PHRs for the TRPs 305 using respective sets of power control parameters, the UE 115-b may receive a first message 315 indicating a first set of power control parameters associated with the first TRP 305-a and a second set of power control parameters associated with the second TRP 305-b. In some examples, at least the second set of power control parameters may be associated with virtual PHR, such that the UE 115-b may generate a PHR associated with the TRP for a reference uplink transmission (e.g., a non-scheduled, virtual transmission). In some examples, the UE 115-b may receive the first message 315 according to the SFN configuration (e.g., at the same frequency via each TRP 305).

In some examples, the first set of power control parameters and the second set of power control parameters may each include a PLRS parameter. The PLRS parameter may enable the UE 115-b to use different pathloss values to generate different PHRs. In some cases, in addition to the PLRS parameter, the first and second sets of power control parameters may include a nominal power parameter (e.g., P0), an alpha value parameter (e.g., α_{b,f,c}(j)), which may correspond to a power control factor, and a close loop index parameter (e.g., ΔT_{C}), which may enable the network entity 105-a to adjust the transmission power of the UE 115-b. In some examples, in addition to the PLRS parameter, the nominal power parameter, the alpha value parameter, and the close loop index parameter, the first and second sets of power control parameters may include a P-MRP parameter, where P-MRP≠0.

The UE 115-b may generate a first PHR for a first uplink transmission associated with a first reference signal resource index (e.g., q_{d}) using the first set of power control parameters corresponding to the first TRP 305-a. In some examples, the first uplink transmission may be an actual PUSCH transmission that is scheduled for transmission by the UE 115-b. In such examples, the UE 115-b may generate the first PHR for the actual PUSCH transmission associated with the first reference signal resource index, and the UE 115-b may generate a second PHR report for a reference uplink transmission associated with a second reference signal resource index (e.g., q_{d}) using the second set of power control parameters corresponding to the second TRP 305-b. The reference uplink transmission may be a PUSCH transmission that is not scheduled for transmission by the UE 115-b, and may be referred to as a virtual PUSCH transmission. In addition, the UE 115-b may obtain the PLRS parameter based on a TCI state related to the reference uplink transmission.

Alternatively, the first uplink transmission may be an non-scheduled, reference uplink transmission. In such cases, because the UE 115-b generates a PHR for two reference uplink transmissions, the first PHR and the second PHR may be virtual PHRs, where the UE 115-b may obtain the PLRS parameter for each PHR based on a respective TCI state corresponding to each reference uplink transmission. The UE 115-b may transmit a second message 320 to the network entity 105-a including the first PHR and the second PHR, the first and second PHRs generated by the UE 115-b as described herein. In addition, the first PHR and the second PHR may be Type 1 PHRs, which indicate a difference between a maximum transmission power of the UE 115-b and an estimate power of an uplink transmission (e.g., the first uplink transmission or the reference uplink transmission), calculated using Equation 1 as described with reference to FIG. 1.

In some cases, the first message 315 may indicate a TCI configuration that identifies that the first uplink transmission (e.g., an actual or reference PUSCH transmission) is associated with a first TCI state, and the reference uplink transmission (e.g., a reference PUSCH transmission) is associated with a second TCI state. As such, the first or second set of power control parameters associated with a TCI state related to the first uplink transmission or the reference uplink transmission for the corresponding power headroom calculation may be the TCI state identified in the TCI configuration. For example, the first or second TCI state may be indicated in a parameter p0AlphaSetforPUSCH in the TCI configuration.

Alternatively, if the TCI configuration fails to identify TCI states corresponding to the first or second set of power control parameters, the first message 315 may include an uplink BWP configuration identifying that the first uplink transmission (e.g., an actual or reference PUSCH transmission) is associated with the first set of power control parameters and that the reference uplink transmission is associated with the second set of power control parameters. For example, the uplink BWP configuration (e.g., BWP-UplinkDedicated) may indicate a set of power control parameters in an uplink power control information element (e.g., ul-powerControl), where the first uplink transmission may be associated with a first uplink power control information element and the reference uplink transmission may be associated with a second uplink power control information element in the uplink BWP configuration.

Alternatively, if the TCI configuration fails to identify the TCI states corresponding to the first or second set of power control parameters, the first message 315 may include a serving cell configuration identifying that the first uplink transmission (e.g., an actual or reference PUSCH transmission) is associated with the first set of power control parameters and that the reference uplink transmission is associated with the second set of power control parameters. For example, the uplink power control information element (e.g., ul-powerControl) may be included in the serving cell configuration (e.g., ServingCellConfig), where the first uplink transmission may be associated with an uplink power control information element with a lowest value and the reference uplink transmission may be associated with an uplink power control information element with a second lowest value. As such, the network entity 105-a may configure the UE 115-b with the first set of power control parameters and the second set of power control parameters which correspond to the first uplink transmission and the reference uplink transmission, respectively, such that the UE 115-b may generate the first PHR and the second PHR for individual TRPs 305.

As described herein, the first and second sets of power control parameters may each include a PLRS parameter, a nominal power parameter, an alpha value parameter, a close loop index parameter, a P-MRP parameter (e.g., P-MRP=0), or a combination thereof. For each different set of parameters (e.g., the PLRS parameter only, the PLRS parameter, the nominal power parameter, the alpha value parameter, and the close loop index parameter, or the PLRS parameter, the nominal power parameter, the alpha value parameter, the close loop index parameter, and the P-MRP parameter), the UE 115-b may generate the first PHR and the second PHR, where the first PHR may be a virtual PHR if the first uplink transmission is a reference (e.g., virtual) uplink transmission, and the second PHR may be a virtual PHR.

In some examples, when the first and second sets of parameters each include a PLRS parameter only or the PLRS parameter, the nominal power parameter, the alpha value parameter, and the close loop index parameter (e.g., each power control parameter described herein except for the P-MRP parameter), the UE 115-b may compute a maximum transmission power (e.g., \tilde{P}_{CMAX,f,c}(i)) assuming MRP=0 dB, additional MRP (A-MRP)=0 dB, P-MRP=0 dB (e.g., the P-MRP not included in the sets of power control parameters), and ΔT_{c}=0. Then, the UE 115-b may determine the power control parameters included in the first and second sets of uplink control parameters based on the TCI configuration, the uplink BWP configuration, or the serving cell configuration as described herein. In some cases, when the first and second sets of parameters each include a PLRS parameter only or the PLRS parameter, the nominal power parameter, the alpha value parameter, the close loop index parameter, and the P-MRP parameter, the UE 115-b may compute the maximum transmission power in the same manner, however the value of the P-MRP value may be nonzero.

In some examples, the first set of power control parameters may be indicated by a first RRC parameter (e.g., pathlossReferenceRS-Id-r17) and a first RRC parameter (e.g., p0AlphaSetforPUSCH-r17) in a TCI associated with the first reference signal index qu, and the second set of power control parameters may be indicated by a second RRC parameter (e.g., pathlossReferenceRS-Id-r17) and a second RRC parameter (e.g., p0AlphaSetforPUSCH-r17) in a TCI associated with the second reference signal index qu. Each RRC parameter p0AlphaSetforPUSCH-r17 may include a set of a parameters including a nominal power parameter, an alpha value parameter, and a close loop index parameter, and each RRC parameter pathlossReferenceRS-Id-r17 may include a PLRS parameter. In some examples, the first set of power control parameters associated with the first reference signal index qu may be indicated by the first RRC parameter pathlossReferenceRS-Id-r17 and the first RRC parameter p0AlphaSetforPUSCH-r17 in an uplink BWP configuration BWP-UplinkDedicated. In addition, the second set of power control parameters associated with the second reference signal index q_{d} may be indicated by the second RRC parameter pathlossReferenceRS-Id-r17 and the second RRC parameter p0AlphaSetforPUSCH-r17 in an uplink BWP configuration BWP-UplinkDedicated. In some cases, the first set of power control parameters associated with the first reference signal index q_{d} may be indicated by the first RRC parameter pathlossReference RS-Id-r17 and the first RRC parameter p0AlphaSetforPUSCH-r17 in a serving cell configuration ServingCellConfig, and the second set of power control parameters associated with the second reference signal index q_{d} may be indicated by the second RRC parameter pathlossReferenceRS-Id-r17 and the second RRC parameter p0AlphaSetforPUSCH-r17 in a serving cell configuration ServingCellConfig.

By using the first set of parameters and the second set of parameters to generate the first PHR and the second PHR as described herein, communications between the UE 115-b and the network entity 105-a may be improved. For example, by communicating the first and second set of power control parameters in the TCI configuration, the uplink BWP configuration, or the serving cell configuration, the UE 115-b and the network entity 105-a may reduce latency by more accurately calculating power headroom values for different TRPs 305. Additionally, generating more accurate power headroom values may reduce failed transmissions and improve overall communications between the UE 115-b and the network entity 105-a, among other benefits.

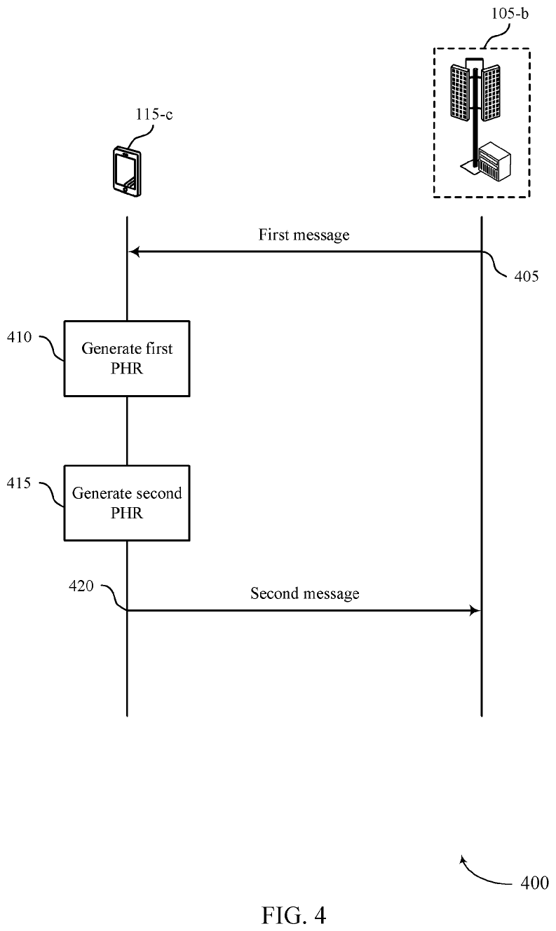

FIG. 4 illustrates an example of a process flow 400 that supports TCI-specific virtual PHR in accordance with one or more aspects of the present disclosure. The process flow 400 may implement aspects of wireless communications systems 100 and 300, or may be implemented by aspects of the wireless communications systems 100 and 300. For example, the process flow 400 may illustrate operations between a UE 115-c and a network entity 105-b, which may be examples of corresponding devices described herein. In the following description of the process flow 400, the operations between the UE 115-c and the network entity 105-b may be transmitted in a different order than the example order shown, or the operations performed by the UE 115-c and the network entity 105-b may be performed in different orders or at different times. Some operations may also be omitted from the process flow 400, and other operations may be added to the process flow 400.

At 405, the UE 115-c may receive, from the network entity 105-b, a first message indicating a first set of power control parameters associated with a first TRP and a second set of power control parameters associated with a second TRP, where at least the second set of power control parameters are associated with virtual PHR. For virtual PHR, the UE 115-c may use a reference uplink transmission (e.g., a virtual PUSCH transmission) to calculate a power headroom, which may not be scheduled for transmission by the UE 115-b.

At 410, the UE 115-c may generate a first PHR for a first uplink transmission associated with a first reference signal resource index (e.g., q_{d}) using the first set of power control parameters. The first uplink transmission may be an actual PUSCH transmission scheduled for transmission by the UE 115-c, or a virtual PUSCH transmission that is not scheduled. The first PHR may be a Type 1 PHR, which may indicate a difference between a maximum transmit power of the UE and an estimated power of the first uplink transmission. In some cases, if the UE 115-c generates the first PHR for a reference (e.g., virtual) first uplink transmission, the first PHR may be based on the first set of power control parameters including any of a nominal transmit power parameter, an alpha value parameter, a PLRS parameter, a close loop index, and a P-MPR value.

At 415, the UE 115-c may generate a second PHR for a reference uplink transmission associated with a second reference signal resource index (e.g., q_{d}) using the second set of power control parameters. The reference uplink transmission may be a reference (e.g., virtual) PUSCH transmission not scheduled for transmission by the UE 115-c. In addition, the second PHR may be a Type 1 PHR. In some cases, if the UE 115-c generates the second PHR for a reference (e.g., virtual) uplink transmission, the second PHR may be based on the second set of power control parameters including any of a nominal transmit power parameter, the alpha value parameter, the PLRS parameter, the close loop index, and the P-MPR value.

At 420, the UE 115-c may transmit a second message to the network entity 105-b that includes the first PHR and the second PHR generated by the UE 115-c. If the first uplink transmission is a reference PUSCH transmission, the first PHR may be a virtual PHR. In addition, the second PHR may be a virtual PHR.

In some aspects, if a UE 115-c transmits a PUSCH associated with a first reference resource index q_{d}, on an active uplink BWP b of a carrier f of a serving cell c in a slot n, and is provided twoPHRMode, the UE 115-c may provide a Type 1 PHR for PUSCH repetition associated with a second reference signal resource index q_{d}. In some cases, if the UE 115-c provides a Type 1 PHR for an actual PUSCH repetition associated with the first reference signal resource index q_{d}, and if the UE 115-c transmits PUSCH repetitions associated with the second reference signal resource index qa in the slot n, the UE 115-a may provide a Type 1 PHR for a first actual PUSCH repetition associated with the second reference signal resource index q_{d} that overlaps with the slot n. Otherwise, the UE 115-c may provide a Type 1 PHR for a reference PUSCH transmission associated with the second reference signal resource index q_{d}, where \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j) and the alpha value α_{b,f,c}(j) are obtained using the parameter P_{O_NOMINAL,PUSCH,f,c}(0) and the parameter p0-PUSCH-AlphaSetId=0, and the PLRS PL_{b,f,c}(q_{d}) is obtained associated with the TCI related to the second reference signal q_{d}, and l=0.

Alternatively, if the UE 115-c provides a Type 1 PHR for a reference PUSCH transmission associated with the first reference signal resource index q_{d}, the UE 115-c may provide a Type 1 PHR for a reference PUSCH transmission associated with the second reference signal resource index q_{d}. For a reference PUSCH transmission associated with the first reference signal resource index q_{d}, \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j) and the alpha value α_{b,f,c}(j) are obtained using the parameter P_{O_NOMINAL,PUSCH,f,c}(0) and the parameter p0-PUSCH-AlphaSetId=0, the PLRS PL_{b,f,c}(q_{d}) is obtained associated with the TCI related to the first reference signal q_{d}, and l=0. For a reference PUSCH transmission associated with the second reference signal resource index q_{d}, \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j) and the alpha value α_{b,f,c}(j) are obtained using the parameter P_{O_NOMINAL,PUSCH,f,c}(0) and the parameter p0-PUSCH-AlphaSetId=0, the path loss reference signal PL_{b,f,c}(q_{d}) is obtained associated with the TCI related to the second reference signal q_{d}, and l=0.

In some aspects, if a UE 115-c transmits a PUSCH associated with a first reference signal resource index q_{d}, on an active uplink BWP b of a carrier f of a serving cell c in a slot n and is provided twoPHRMode, the UE 115-c may provide a Type 1 PHR for a PUSCH repetition associated with a second reference signal resource index q_{d}. If the UE 115-c provides a Type 1 PHR for an actual PUSCH repetition associated with the first reference signal resource index q_{d}, and if the UE 115-c transmits PUSCH repetitions associated with the second reference signal resource index q_{d} in the slot n, the UE 115-c may provide a Type 1 PHR for a first actual PUSCH repetition associated with the second reference signal resource index q_{d} that overlaps with slot n. Otherwise, if the UE 115-c provides a Type 1 PHR for a reference PUSCH transmission associated with the second reference signal resource index q_{d}, where \tilde{P}_{CMAX,f,c}(i) is computed assuming MPR=0 dB, A-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the value of P-MPR, the nominal power P_{O_PUSCH,b,f,c}(j), the alpha value α_{b,f,c}(j), the PLRSPL_{b,f,c}(q_{d}) and the close loop index l are associated with the TCI state related to the second reference signal resource index q_{d}.

Alternatively, if the UE 115-c provides a Type 1 PHR for a reference PUSCH transmission associated with the first reference signal resource index q_{d}, the UE 115-c may provide a Type 1 PHR for a reference PUSCH transmission associated with the second reference signal resource index q_{d}, where for a reference PUSCH transmission associated with the first reference signal resource index q_{d}, \tilde{P}_{CMAX,f,c}(i) is computed assuming MPR=0 dB, A-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the value of P-MPR, the nominal power P_{O_PUSCH,b,f,c}(j), the alpha value α_{b,f,c}(j), the PLRS PL_{b,f,c}(q_{d}) and the close loop index l are associated with the TCI state related to the first reference signal resource index q_{d}. For a reference PUSCH transmission associated with the second reference signal resource index q_{d}, \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the value of P-MPR, the nominal power P_{O_PUSCH,b,f,c}(j) the alpha value α_{b,f,c}(j), the PLRS PL_{b,f,c}(Aa) and the close loop index l are associated with the TCI state related to the second reference signal resource index q_{d}.

In some aspects, if a UE 115-c transmits a PUSCH associated with a first reference signal resource index q_{d}, on an active uplink BWP b of a carrier f of a serving cell c in a slot n and is provided twoPHRMode, the UE 115-c may provide a Type 1 PHR for PUSCH repetition associated with a second reference signal resource index q_{d}, where if the UE 115-c provides a Type 1 PHR for an actual PUSCH repetition associated with the first reference signal resource index q_{d}, and if the UE 115-c transmits PUSCH repetitions associated with the second reference signal resource index q_{d} in the slot n, the UE 115-c may provide a Type 1 PHR for a first actual PUSCH repetition associated with the second reference signal resource index q_{d} that overlaps with the slot n. Otherwise, the UE 115-c may provide a Type 1 PHR for a reference PUSCH transmission associated with the second reference signal resource index q_{d}, where \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j), the alpha value α_{b,f,c}(j), the path loss reference signal PL_{b,f,c}(q_{d}) and the close loop index l are associated with the TCI state related to the second reference signal resource index q_{d}.

Alternatively, if the UE 115-c provides a Type 1 PHR for a reference PUSCH transmission associated with the first reference signal resource index q_{d}, the UE 115-c may provide a Type 1 PHR for a reference PUSCH transmission associated with the second reference signal resource index q_{d}, where for a reference PUSCH transmission associated with the first reference signal resource index q_{d}, \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j), the alpha value α_{b,f,c}(j), the path loss reference signal PL_{b,f,c}(q_{d}) and the close loop index l are associated with the TCI state related to the first reference signal resource index q_{d}. For a reference PUSCH transmission associated with the second reference signal resource index q_{d}, \tilde{P}_{CMAX,f,c}(i) is computed assuming MPR=0 dB, A-MPR=0 dB, P-MPR=0 dB, and ΔT_{C}=0 dB. MPR, A-MPR, P-MPR and ΔT_{C} are defined in [8-1, 3GPP TS 38.101-1], [8-2, 3GPP TS38.101-2] and [8-3, 3GPP TS 38.101-3]. The remaining parameters are defined in clause 7.1.1 where the nominal power P_{O_PUSCH,b,f,c}(j), the alpha value α_{b,f,c}(j), the path loss reference signal PL_{b,f,c}(q_{d}) and the close loop index l are associated with the TCI state related to the second reference signal resource index q_{d}.

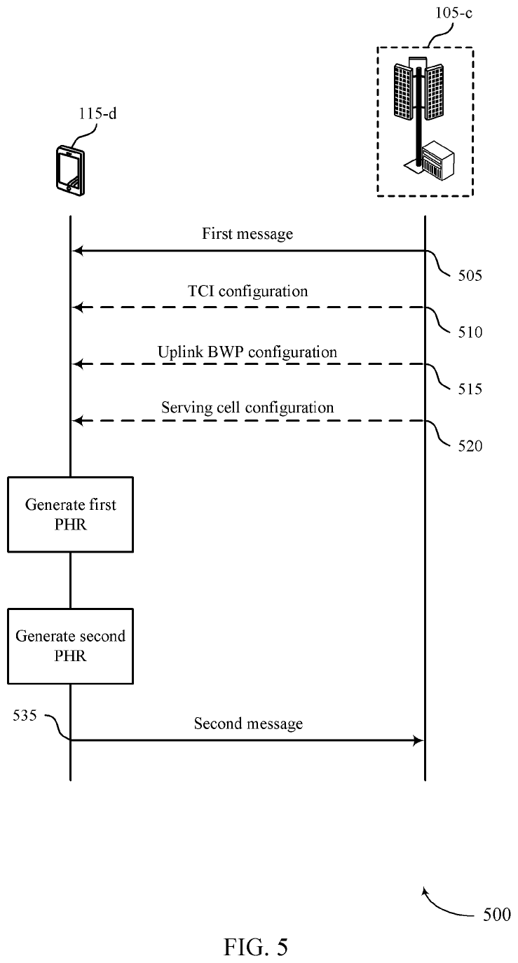

FIG. 5 illustrates an example of a process flow 500 that supports TCI-specific virtual PHR in accordance with one or more aspects of the present disclosure. The process flow 500 may implement aspects of wireless communications systems 100 and 300, or may be implemented by aspects of the wireless communications systems 100 and 300. For example, the process flow 500 may illustrate operations between a UE 115-d and a network entity 105-c, which may be examples of corresponding devices described herein. In the following description of the process flow 500, the operations between the UE 115-d and the network entity 105-c may be transmitted in a different order than the example order shown, or the operations performed by the UE 115-d and the network entity 105-c may be performed in different orders or at different times. Some operations may also be omitted from the process flow 500, and other operations may be added to the process flow 500.

At 505, the UE 115-d may receive, from the network entity 105-c, a first message indicating a first set of power control parameters associated with a first TRP and a second set of power control parameters associated with a second TRP, where at least the second set of power control parameters are associated with virtual PHR. For virtual PHR, the UE 115-d may use a reference uplink transmission (e.g., a virtual PUSCH transmission) to calculate a power headroom, which may not be scheduled for transmission by the UE 115-c. The first and second sets of power control parameters may include a PLRS parameter, a nominal power parameter, an alpha value parameter, a close loop index parameter, a P-MRP parameter, or a combination thereof.

At 510, the UE 115-d may receive the first message indicating a TCI configuration identifying that the first uplink transmission is associated with a first TCI state and the reference uplink transmission is associated with a second TCI state. The TCI configuration may enable the UE 115-d to determine the first and second sets of power control parameters.

At 515, the UE 115-d may receive the first message indicating an uplink BWP configuration identifying that the first uplink transmission is associated with the first set of power control parameters and that the reference uplink transmission is associated with the second set of power control parameters. For example, the uplink BWP configuration may identify the association between the uplink transmissions and first and second sets of power control parameters if that information is left out of the TCI configuration.

At 520, the UE 115-d may receive the first message indicating a serving cell configuration identifying that the first uplink transmission is associated with the first set of power control parameters and that the reference uplink transmission is associated with the second set of power control parameters. For example, the serving cell configuration may identify the association between the uplink transmissions and first and second sets of power control parameters if that information is left out of the TCI configuration.

At 525, the UE 115-d may generate a first PHR for a first uplink transmission associated with a first reference signal resource index (e.g., q_{d}) using the first set of power control parameters. The first uplink transmission may be an actual PUSCH transmission scheduled for transmission by the UE 115-d or a virtual PUSCH transmission that is not scheduled. The first PHR may be a Type 1 PHR, which may indicate a difference between a maximum transmit power of the UE and an estimated power of the first uplink transmission.

At 530, the UE 115-d may generate a second PHR for a reference uplink transmission associated with a second reference signal resource index (e.g., q_{d}) using the second set of power control parameters. The reference uplink transmission may be a reference (e.g., virtual) PUSCH transmission not scheduled for transmission by the UE 115-d. In addition, the second PHR may be a Type 1 PHR.

At 535, the UE 115-d may transmit a second message to the network entity 105-c that includes the first PHR and the second PHR generated by the UE 115-d. If the first uplink transmission is a reference PUSCH transmission, the first PHR may be a virtual PHR. In addition, the second PHR may be a virtual PHR.

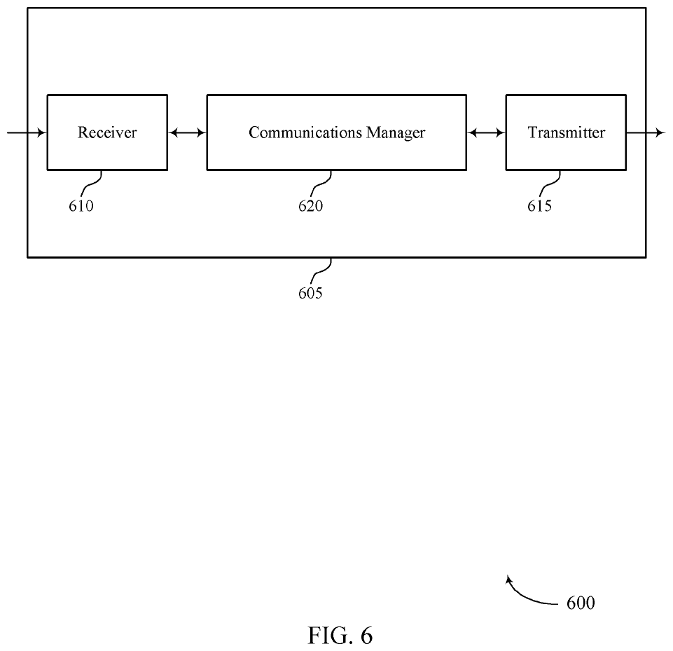

FIG. 6 shows a block diagram 600 of a device 605 that supports TCI-specific virtual PHR in accordance with one or more aspects of the present disclosure. The device 605 may be an example of aspects of a UE 115 as described herein. The device 605 may include a receiver 610, a transmitter 615, and a communications manager 620. The device 605 may also include a processor. The device 605 may also include one or more processors, memory coupled with the one or more processors, and instructions stored in the memory that are executable by the one or more processors to enable the one or more processors to perform the TCI-specific PHR features discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to TCI-specific virtual PHR). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TCI-specific virtual PHR). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of TCI-specific virtual PHR as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a first message indicating a first set of power control parameters associated with a first transmission reception point and a second set of power control parameters associated with a second transmission reception point, where at least the second set of power control parameters are associated with virtual PHR. The communications manager 620 may be configured as or otherwise support a means for transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for virtual PHR for multiple TRPs, which may reduce latency and improve communications between a network node and a UE.

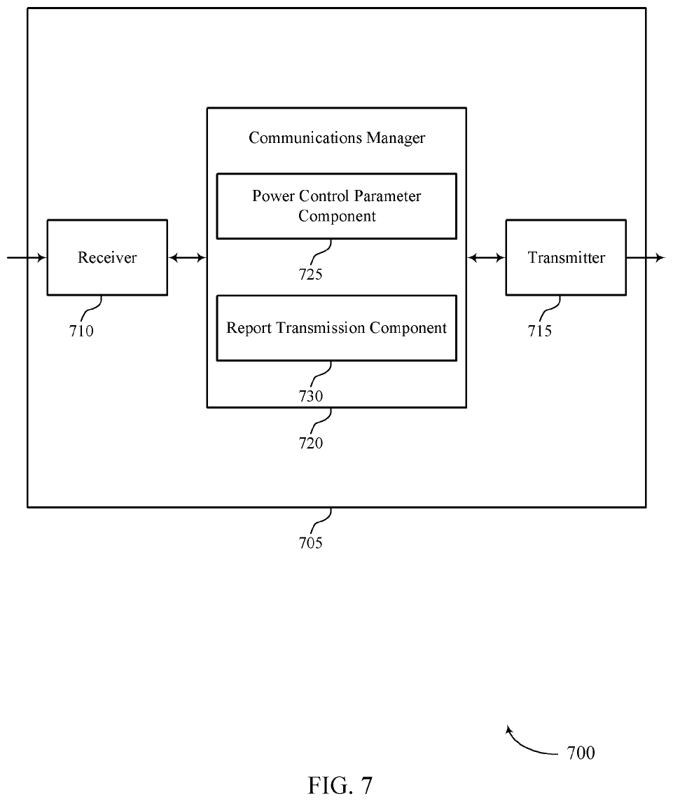

FIG. 7 shows a block diagram 700 of a device 705 that supports TCI-specific virtual PHR in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to TCI-specific virtual PHR). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to TCI-specific virtual PHR). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of TCI-specific virtual PHR as described herein. For example, the communications manager 720 may include a power control parameter component 725 a report transmission component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The power control parameter component 725 may be configured as or otherwise support a means for receiving a first message indicating a first set of power control parameters associated with a first transmission reception point and a second set of power control parameters associated with a second transmission reception point, where at least the second set of power control parameters are associated with virtual PHR. The report transmission component 730 may be configured as or otherwise support a means for transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

In some cases, the power control parameter component 725 and the report transmission component 730 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the power control parameter component 725 and the report transmission component 730 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

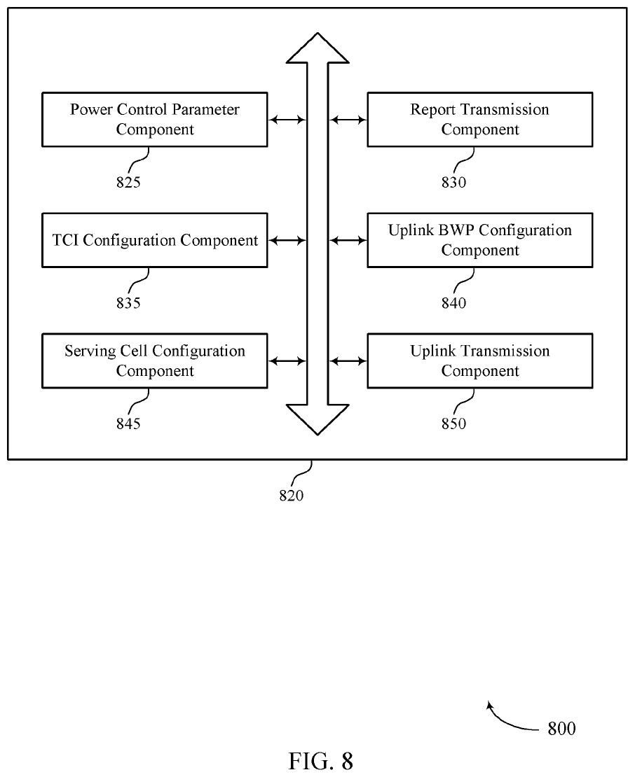

FIG. 8 shows a block diagram 800 of a communications manager 820 that supports TCI-specific virtual PHR in accordance with one or more aspects of the present disclosure. The communications manager 820 may be an example of aspects of a communications manager 620, a communications manager 720, or both, as described herein. The communications manager 820, or various components thereof, may be an example of means for performing various aspects of TCI-specific virtual PHR as described herein. For example, the communications manager 820 may include a power control parameter component 825, a report transmission component 830, a TCI configuration component 835, an uplink BWP configuration component 840, a serving cell configuration component 845, an uplink transmission component 850, or any combination thereof. Each of these components may communicate, directly or indirectly, with one another (e.g., via one or more buses).

The communications manager 820 may support wireless communication at a UE in accordance with examples as disclosed herein. The power control parameter component 825 may be configured as or otherwise support a means for receiving a first message indicating a first set of power control parameters associated with a first transmission reception point and a second set of power control parameters associated with a second transmission reception point, where at least the second set of power control parameters are associated with virtual PHR. The report transmission component 830 may be configured as or otherwise support a means for transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

In some examples, to support receiving the first message, the TCI configuration component 835 may be configured as or otherwise support a means for receiving the first message indicating a TCI configuration identifying that the first uplink transmission is associated with a first TCI state and the reference uplink transmission is associated with a second TCI state.

In some examples, to support receiving the first message, the uplink BWP configuration component 840 may be configured as or otherwise support a means for receiving the first message indicating an uplink BWP configuration identifying that the first uplink transmission is associated with the first set of power control parameters and that the reference uplink transmission is associated with the second set of power control parameters.

In some examples, to support receiving the first message, the serving cell configuration component 845 may be configured as or otherwise support a means for receiving the first message indicating a serving cell configuration identifying that the first uplink transmission is associated with the first set of power control parameters and that the reference uplink transmission is associated with the second set of power control parameters.

In some examples, the first set of power control parameters and the second set of power control parameters include a pathloss reference signal parameter. In some examples, the first set of power control parameters and the second set of power control parameters further include a nominal power parameter, an alpha value parameter, and a close loop index parameter.

In some examples, the first set of power control parameters and the second set of power control parameters further include a power management maximum power reduction parameter. In some examples, the first uplink transmission includes an actual uplink transmission. In some examples, the first uplink transmission includes a reference uplink transmission.

In some examples, the first PHR and the second PHR are a first type of PHR that indicates a difference between a maximum transmit power of the UE and an estimated power of an uplink transmission.

In some examples, to support receiving the first message, the power control parameter component 825 may be configured as or otherwise support a means for receiving the first message according to a single frequency network configuration.

In some cases, the power control parameter component 825, the report transmission component 830, the TCI configuration component 835, the uplink BWP configuration component 840, the serving cell configuration component 845, and the uplink transmission component 850 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the power control parameter component 825, the report transmission component 830, the TCI configuration component 835, the uplink BWP configuration component 840, the serving cell configuration component 845, and the uplink transmission component 850 discussed herein.

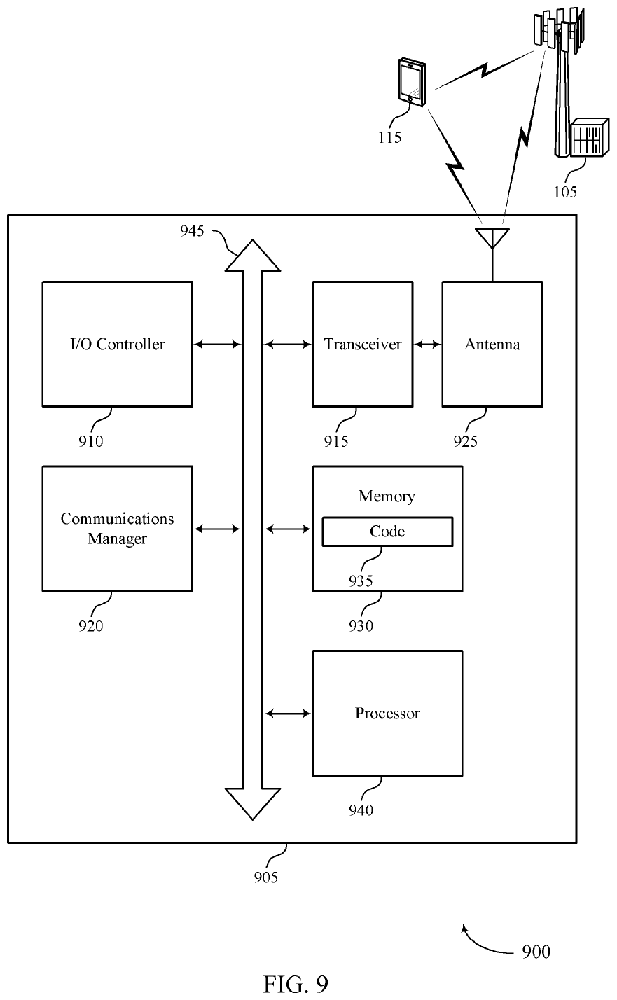

FIG. 9 shows a diagram of a system 900 including a device 905 that supports TCI-specific virtual PHR in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting TCI-specific virtual PHR). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a first message indicating a first set of power control parameters associated with a first transmission reception point and a second set of power control parameters associated with a second transmission reception point, where at least the second set of power control parameters are associated with virtual PHR. The communications manager 920 may be configured as or otherwise support a means for transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

By including or configuring the communications manager 920 in accordance with examples as described herein, the device 905 may support techniques for virtual PHR for multiple TRPs, which may reduce latency and improve communications between a network node and a UE.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of TCI-specific virtual PHR as described herein, or the processor 940 and the memory 930 may be otherwise configured to perform or support such operations.

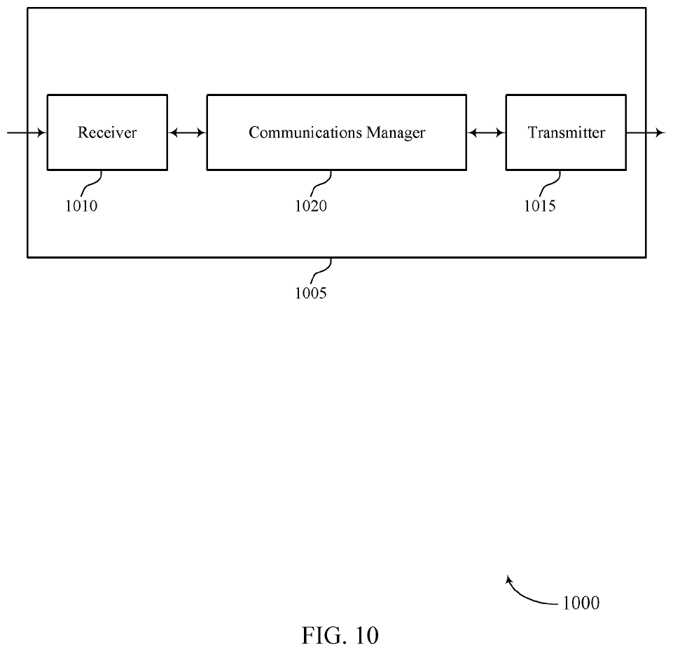

FIG. 10 shows a block diagram 1000 of a device 1005 that supports TCI-specific virtual PHR in accordance with one or more aspects of the present disclosure. The device 1005 may be an example of aspects of a network node as described herein. The device 1005 may include a receiver 1010, a transmitter 1015, and a communications manager 1020. The device 1005 may also include a processor. The device 1005 may also include one or more processors, memory coupled with the one or more processors, and instructions stored in the memory that are executable by the one or more processors to enable the one or more processors to perform the TCI-specific PHR features discussed herein. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of TCI-specific virtual PHR as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network node in accordance with examples as disclosed herein. For example, the communications manager 1020 may be configured as or otherwise support a means for transmitting a first message indicating a first set of power control parameters associated with a first transmission reception point and a second set of power control parameters associated with a second transmission reception point, where at least the second set of power control parameters are associated with virtual PHR. The communications manager 1020 may be configured as or otherwise support a means for receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for virtual PHR for multiple TRPs, which may reduce latency and improve communications between a network node and a UE.

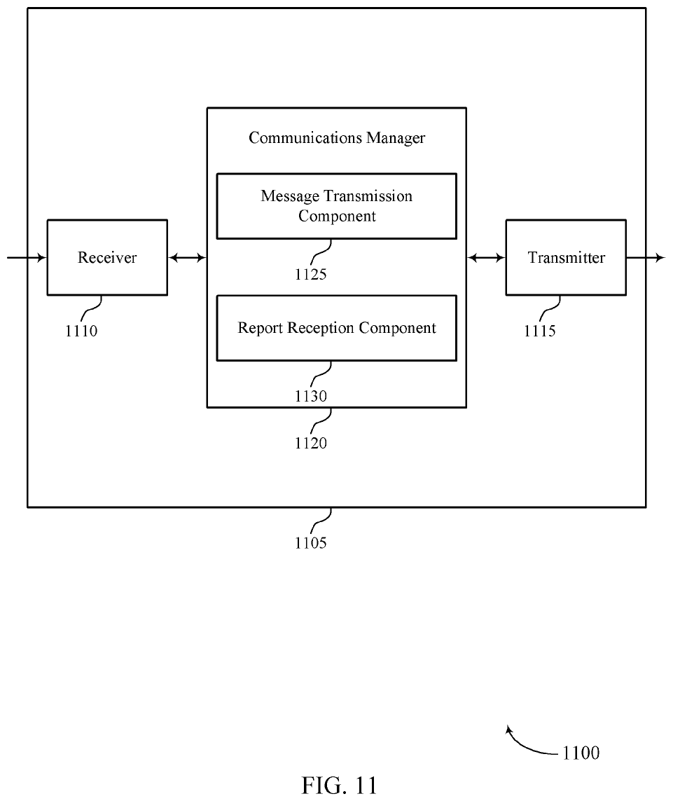

FIG. 11 shows a block diagram 1100 of a device 1105 that supports TCI-specific virtual PHR in accordance with one or more aspects of the present disclosure. The device 1105 may be an example of aspects of a device 1005 or a network node 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of TCI-specific virtual PHR as described herein. For example, the communications manager 1120 may include a message transmission component 1125 a report reception component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. The message transmission component 1125 may be configured as or otherwise support a means for transmitting a first message indicating a first set of power control parameters associated with a first transmission reception point and a second set of power control parameters associated with a second transmission reception point, where at least the second set of power control parameters are associated with virtual PHR. The report reception component 1130 may be configured as or otherwise support a means for receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

In some cases, the message transmission component 1125 and the report reception component 1130 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message transmission component 1125 and the report reception component 1130 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

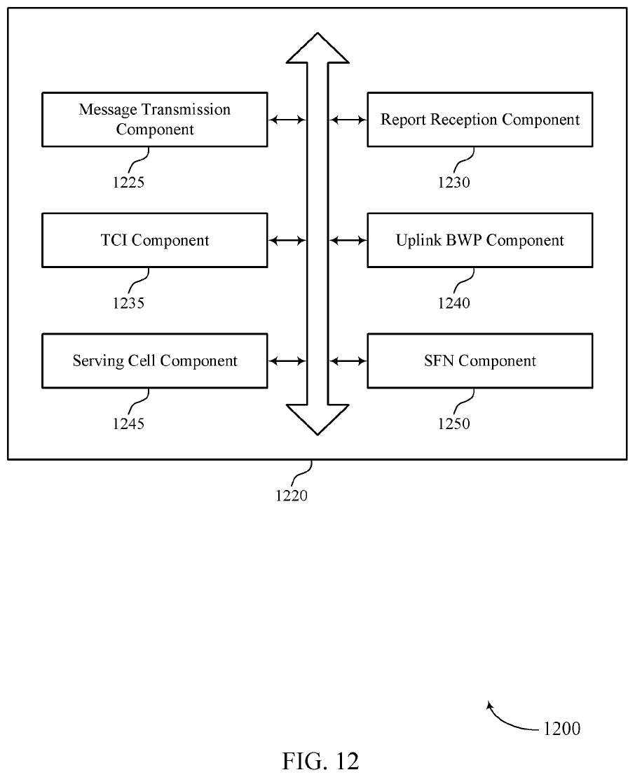

FIG. 12 shows a block diagram 1200 of a communications manager 1220 that supports TCI-specific virtual PHR in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of TCI-specific virtual PHR as described herein. For example, the communications manager 1220 may include a message transmission component 1225, a report reception component 1230, a TCI component 1235, an uplink BWP component 1240, a serving cell component 1245, an SFN component 1250, or any combination thereof. Each of these components may communicate, directly or indirectly, with one another (e.g., via one or more buses).

The communications manager 1220 may support wireless communication at a network node in accordance with examples as disclosed herein. The message transmission component 1225 may be configured as or otherwise support a means for transmitting a first message indicating a first set of power control parameters associated with a first transmission reception point and a second set of power control parameters associated with a second transmission reception point, where at least the second set of power control parameters are associated with virtual PHR. The report reception component 1230 may be configured as or otherwise support a means for receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

In some examples, to support transmitting the first message, the TCI component 1235 may be configured as or otherwise support a means for transmitting the first message indicating a TCI configuration identifying that the first uplink transmission is associated with a first TCI state and the reference uplink transmission is associated with a second TCI state.

In some examples, to support transmitting the first message, the uplink BWP component 1240 may be configured as or otherwise support a means for transmitting the first message indicating an uplink BWP configuration identifying that the first uplink transmission is associated with the first set of power control parameters and that the reference uplink transmission is associated with the second set of power control parameters.

In some examples, to support transmitting the first message, the serving cell component 1245 may be configured as or otherwise support a means for transmitting the first message indicating a serving cell configuration identifying that the first uplink transmission is associated with the first set of power control parameters and that the reference uplink transmission is associated with the second set of power control parameters.

In some examples, the first set of power control parameters and the second set of power control parameters include a pathloss reference signal parameter. In some examples, the first set of power control parameters and the second set of power control parameters further include a nominal power parameter, an alpha value parameter, and a close loop index parameter.

In some examples, the first set of power control parameters and the second set of power control parameters further include a power management maximum power reduction parameter. In some examples, the first uplink transmission includes an actual uplink transmission. In some examples, the first uplink transmission includes a reference uplink shared channel transmission.

In some examples, the first PHR and the second PHR are a first type PHR that indicates a difference between a maximum transmit power of the UE and an estimated power of an uplink transmission.

In some examples, to support receiving the first message, the SFN component 1250 may be configured as or otherwise support a means for receiving the first message according to a single frequency network configuration.

In some cases, the message transmission component 1225, the report reception component 1230, the TCI component 1235, the uplink BWP component 1240, the serving cell component 1245, and the SFN component 1250 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the message transmission component 1225, the report reception component 1230, the TCI component 1235, the uplink BWP component 1240, the serving cell component 1245, and the SFN component 1250 discussed herein.

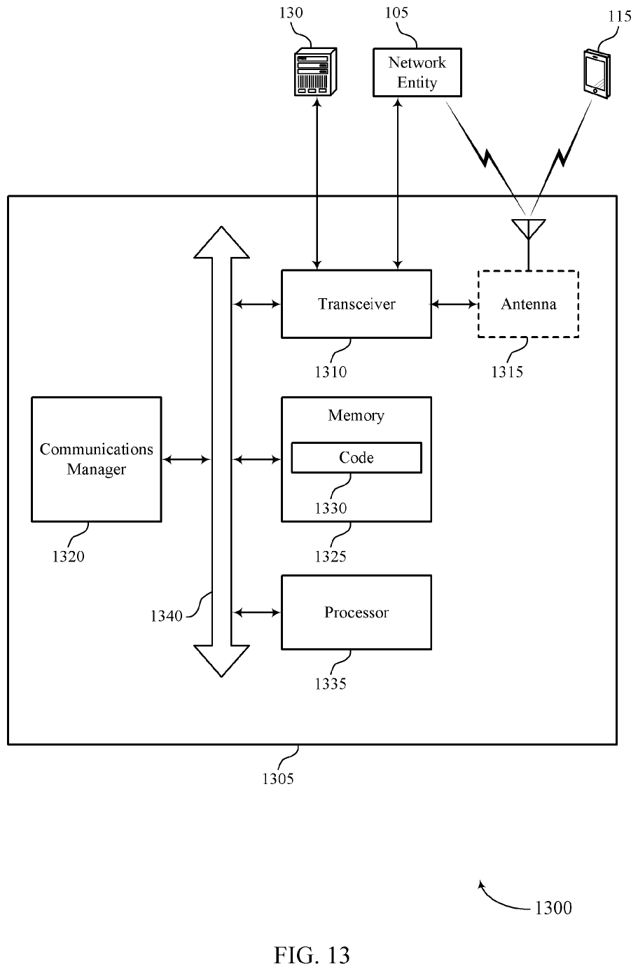

FIG. 13 shows a diagram of a system 1300 including a device 1305 that supports TCI-specific virtual PHR in accordance with one or more aspects of the present disclosure. The device 1305 may be an example of or include the components of a device 1005, a device 1105, or a network node as described herein. The device 1305 may include components for bi-directional voice and data communications including components for transmitting and receiving communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting TCI-specific virtual PHR). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network node in accordance with examples as disclosed herein. For example, the communications manager 1320 may be configured as or otherwise support a means for transmitting a first message indicating a first set of power control parameters associated with a first transmission reception point and a second set of power control parameters associated with a second transmission reception point, where at least the second set of power control parameters are associated with virtual PHR. The communications manager 1320 may be configured as or otherwise support a means for receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

By including or configuring the communications manager 1320 in accordance with examples as described herein, the device 1305 may support techniques for virtual PHR for multiple TRPs, which may reduce latency and improve communications between a network node and a UE.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of TCI-specific virtual PHR as described herein, or the processor 1335 and the memory 1325 may be otherwise configured to perform or support such operations.

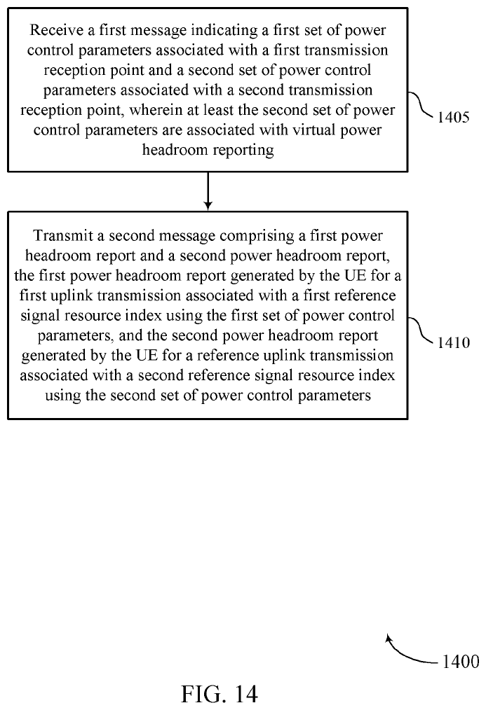

FIG. 14 shows a flowchart illustrating a method 1400 that supports TCI-specific virtual PHR in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first message indicating a first set of power control parameters associated with a first transmission reception point and a second set of power control parameters associated with a second transmission reception point, where at least the second set of power control parameters are associated with virtual PHR. The operations of 1405 may be performed in accordance with examples as disclosed herein. In some examples, aspects of the operations of 1405 may be performed by a power control parameter component 825 as described with reference to FIG. 8.

At 1410, the method may include transmitting a second message including a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters. The operations of 1410 may be performed in accordance with examples as disclosed herein. In some examples, aspects of the operations of 1410 may be performed by a report transmission component 830 as described with reference to FIG. 8.

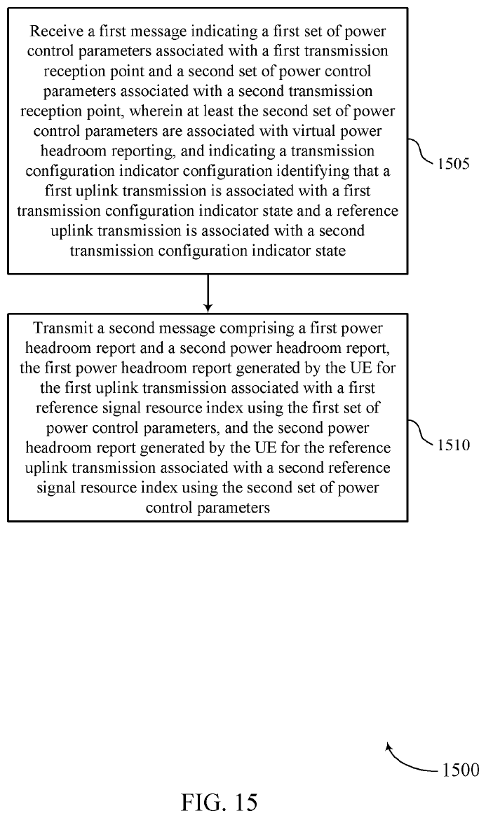

FIG. 15 shows a flowchart illustrating a method 1500 that supports TCI-specific virtual PHR in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first message indicating a first set of power control parameters associated with a first transmission reception point and a second set of power control parameters associated with a second transmission reception point, where at least the second set of power control parameters are associated with virtual PHR, and indicating a TCI configuration identifying that a first uplink transmission is associated with a first TCI state and a reference uplink transmission is associated with a second TCI state. The operations of 1505 may be performed in accordance with examples as disclosed herein. In some examples, aspects of the operations of 1505 may be performed by a power control parameter component 825 as described with reference to FIG. 8.

At 1510, the method may include transmitting a second message including a first PHR and a second PHR, the first PHR generated by the UE for the first uplink transmission associated with a first reference signal resource index using the first set of power control parameters, and the second PHR generated by the UE for the reference uplink transmission associated with a second reference signal resource index using the second set of power control parameters. The operations of 1510 may be performed in accordance with examples as disclosed herein. In some examples, aspects of the operations of 1510 may be performed by a report transmission component 830 as described with reference to FIG. 8.

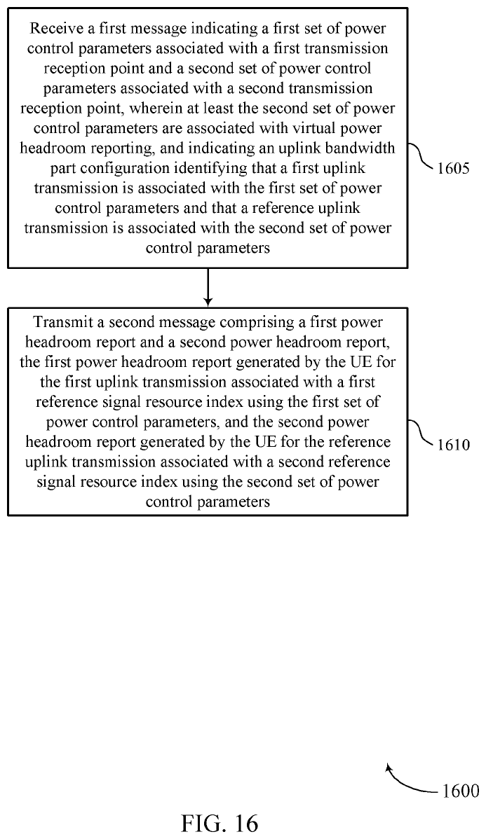

FIG. 16 shows a flowchart illustrating a method 1600 that supports TCI-specific virtual PHR in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a first message indicating a first set of power control parameters associated with a first transmission reception point and a second set of power control parameters associated with a second transmission reception point, where at least the second set of power control parameters are associated with virtual PHR, and indicating an uplink BWP configuration identifying that a first uplink transmission is associated with the first set of power control parameters and that a reference uplink transmission is associated with the second set of power control parameters. The operations of 1605 may be performed in accordance with examples as disclosed herein. In some examples, aspects of the operations of 1605 may be performed by a power control parameter component 825 as described with reference to FIG. 8.

At 1610, the method may include receiving the first message indicating an uplink BWP configuration identifying that the first uplink transmission is associated with the first set of power control parameters and that the reference uplink transmission is associated with the second set of power control parameters. The operations of 1610 may be performed in accordance with examples as disclosed herein. In some examples, aspects of the operations of 1610 may be performed by an uplink BWP configuration component 840 as described with reference to FIG. 8.

At 1610, the method may include transmitting a second message including a first PHR and a second PHR, the first PHR generated by the UE for the first uplink transmission associated with a first reference signal resource index using the first set of power control parameters, and the second PHR generated by the UE for the reference uplink transmission associated with a second reference signal resource index using the second set of power control parameters. The operations of 1610 may be performed in accordance with examples as disclosed herein. In some examples, aspects of the operations of 1610 may be performed by a report transmission component 830 as described with reference to FIG. 8.

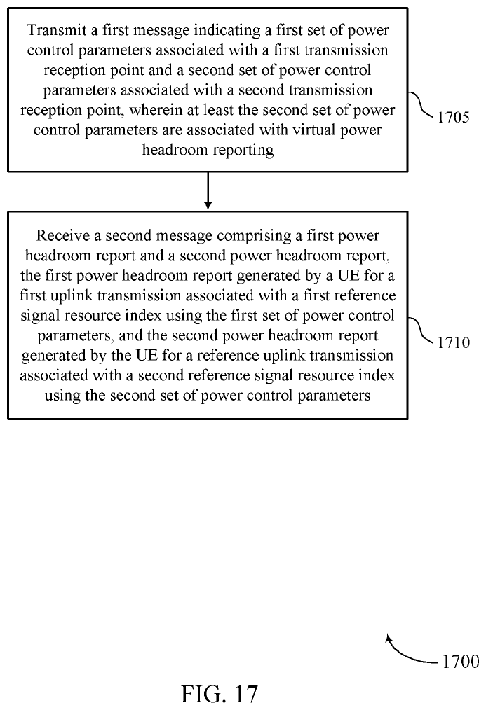

FIG. 17 shows a flowchart illustrating a method 1700 that supports TCI-specific virtual PHR in accordance with one or more aspects of the present disclosure. The operations of the method 1700 may be implemented by a network node or its components as described herein. For example, the operations of the method 1700 may be performed by a network node as described with reference to FIGS. 1 through 5 and 10 through 13. In some examples, a network node may execute a set of instructions to control the functional elements of the network node to perform the described functions. Additionally, or alternatively, the network node may perform aspects of the described functions using special-purpose hardware.

At 1705, the method may include transmitting a first message indicating a first set of power control parameters associated with a first transmission reception point and a second set of power control parameters associated with a second transmission reception point, where at least the second set of power control parameters are associated with virtual PHR. The operations of 1705 may be performed in accordance with examples as disclosed herein. In some examples, aspects of the operations of 1705 may be performed by a message transmission component 1225 as described with reference to FIG. 12.

At 1710, the method may include receiving a second message including a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters. The operations of 1710 may be performed in accordance with examples as disclosed herein. In some examples, aspects of the operations of 1710 may be performed by a report reception component 1230 as described with reference to FIG. 12.

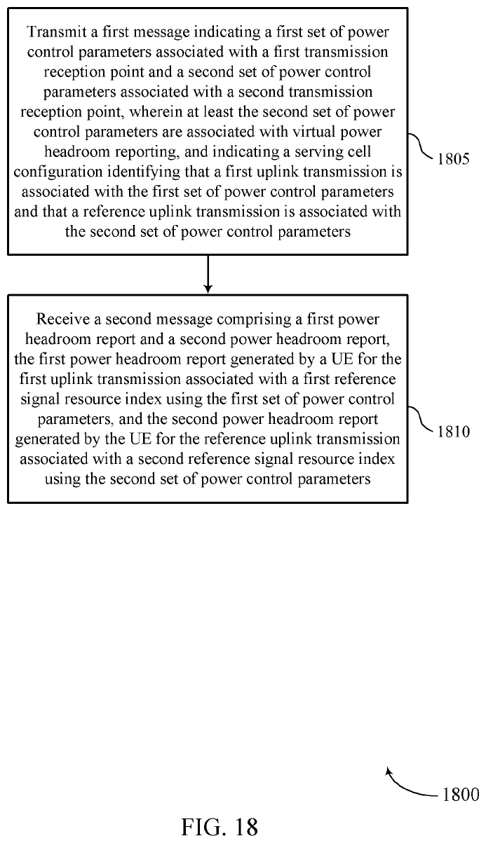

FIG. 18 shows a flowchart illustrating a method 1800 that supports TCI-specific virtual PHR in accordance with one or more aspects of the present disclosure. The operations of the method 1800 may be implemented by a network node or its components as described herein. For example, the operations of the method 1800 may be performed by a network node as described with reference to FIGS. 1 through 5 and 10 through 13. In some examples, a network node may execute a set of instructions to control the functional elements of the network node to perform the described functions. Additionally, or alternatively, the network node may perform aspects of the described functions using special-purpose hardware.

At 1805, the method may include transmitting a first message indicating a first set of power control parameters associated with a first transmission reception point and a second set of power control parameters associated with a second transmission reception point, where at least the second set of power control parameters are associated with virtual PHR, and indicating a serving cell configuration identifying that a first uplink transmission is associated with the first set of power control parameters and that a reference uplink transmission is associated with the second set of power control parameters. The operations of 1805 may be performed in accordance with examples as disclosed herein. In some examples, aspects of the operations of 1805 may be performed by a message transmission component 1225 as described with reference to FIG. 12.

At 1810, the method may include receiving a second message including a first PHR and a second PHR, the first PHR generated by a UE for the first uplink transmission associated with a first reference signal resource index using the first set of power control parameters, and the second PHR generated by the UE for the reference uplink transmission associated with a second reference signal resource index using the second set of power control parameters. The operations of 1810 may be performed in accordance with examples as disclosed herein. In some examples, aspects of the operations of 1810 may be performed by a report reception component 1230 as described with reference to FIG. 12.

The following provides an overview of aspects of the present disclosure:

Aspect 1: A method for wireless communication at a UE, comprising: receiving a first message indicating a first set of power control parameters associated with a first transmission reception point and a second set of power control parameters associated with a second transmission reception point, wherein at least the second set of power control parameters are associated with virtual PHR; and transmitting a second message comprising a first PHR and a second PHR, the first PHR generated by the UE for a first uplink transmission associated with a first reference signal resource index using the first set of power control parameters, and the second PHR generated by the UE for a reference uplink transmission associated with a second reference signal resource index using the second set of power control parameters.

Aspect 2: The method of aspect 1, wherein receiving the first message comprises: receiving the first message indicating a TCI configuration identifying that the first uplink transmission is associated with a first TCI state and the reference uplink transmission is associated with a second TCI state.

Aspect 3: The method of any of aspects 1 through 2, wherein receiving the first message comprises: receiving the first message indicating an uplink BWP configuration identifying that the first uplink transmission is associated with the first set of power control parameters and that the reference uplink transmission is associated with the second set of power control parameters.

Aspect 4: The method of any of aspects 1 through 3, wherein receiving the first message comprises: receiving the first message indicating a serving cell configuration identifying that the first uplink transmission is associated with the first set of power control parameters and that the reference uplink transmission is associated with the second set of power control parameters.

Aspect 5: The method of any of aspects 1 through 4, wherein the first set of power control parameters and the second set of power control parameters comprise a pathloss reference signal parameter.

Aspect 6: The method of aspect 5, wherein the first set of power control parameters and the second set of power control parameters further comprise a nominal power parameter, an alpha value parameter, and a close loop index parameter.

Aspect 7: The method of aspect 6, wherein the first set of power control parameters and the second set of power control parameters further comprise a power management maximum power reduction parameter.

Aspect 8: The method of any of aspects 1 through 7, wherein the first uplink transmission comprises an actual uplink transmission.

Aspect 9: The method of any of aspects 1 through 8, wherein the first uplink transmission comprises a reference uplink transmission.

Aspect 10: The method of any of aspects 1 through 9, wherein the first PHR and the second PHR are a first type of PHR that indicates a difference between a maximum transmit power of the UE and an estimated power of an uplink transmission.

Aspect 11: The method of any of aspects 1 through 10, wherein receiving the first message comprises: receiving the first message according to a single frequency network configuration.

Aspect 12: A method for wireless communication at a network node, comprising: transmitting a first message indicating a first set of power control parameters associated with a first transmission reception point and a second set of power control parameters associated with a second transmission reception point, wherein at least the second set of power control parameters are associated with virtual PHR; and receiving a second message comprising a first PHR and a second PHR, the first PHR generated by a UE for a first uplink transmission associated with a first reference signal resource index using the first set of power control parameters, and the second PHR generated by the UE for a reference uplink transmission associated with a second reference signal resource index using the second set of power control parameters.

Aspect 13: The method of aspect 12, wherein transmitting the first message comprises: transmitting the first message indicating a TCI configuration identifying that the first uplink transmission is associated with a first TCI state and the reference uplink transmission is associated with a second TCI state.

Aspect 14: The method of any of aspects 12 through 13, wherein transmitting the first message comprises: transmitting the first message indicating an uplink BWP configuration identifying that the first uplink transmission is associated with the first set of power control parameters and that the reference uplink transmission is associated with the second set of power control parameters.

Aspect 15: The method of any of aspects 12 through 14, wherein transmitting the first message comprises: transmitting the first message indicating a serving cell configuration identifying that the first uplink transmission is associated with the first set of power control parameters and that the reference uplink transmission is associated with the second set of power control parameters.

Aspect 16: The method of any of aspects 12 through 15, wherein the first set of power control parameters and the second set of power control parameters comprise a pathloss reference signal parameter.

Aspect 17: The method of aspect 16, wherein the first set of power control parameters and the second set of power control parameters further comprise a nominal power parameter, an alpha value parameter, and a close loop index parameter.

Aspect 18: The method of aspect 17, wherein the first set of power control parameters and the second set of power control parameters further comprise a power management maximum power reduction parameter.

Aspect 19: The method of any of aspects 12 through 18, wherein the first uplink transmission comprises an actual uplink transmission.

Aspect 20: The method of any of aspects 12 through 19, wherein the first uplink transmission comprises a reference uplink shared channel transmission.

Aspect 21: The method of any of aspects 12 through 20, wherein the first PHR and the second PHR are a first type PHR that indicates a difference between a maximum transmit power of the UE and an estimated power of an uplink transmission.

Aspect 22: The method of any of aspects 12 through 21, wherein receiving the first message comprises: receiving the first message according to a single frequency network configuration.

Aspect 23: An apparatus for wireless communication at a UE, comprising a processor; memory coupled with the processor; and instructions stored in the memory and executable by the processor to cause the apparatus to perform a method of any of aspects 1 through 11.

Aspect 24: An apparatus for wireless communication at a UE, comprising at least one means for performing a method of any of aspects 1 through 11.

Aspect 25: A non-transitory computer-readable medium storing code for wireless communication at a UE, the code comprising instructions executable by a processor to perform a method of any of aspects 1 through 11.

Aspect 26: An apparatus for wireless communication at a network node, comprising a processor; memory coupled with the processor; and instructions stored in the memory and executable by the processor to cause the apparatus to perform a method of any of aspects 12 through 22.

Aspect 27: An apparatus for wireless communication at a network node, comprising at least one means for performing a method of any of aspects 12 through 22.

Aspect 28: A non-transitory computer-readable medium storing code for wireless communication at a network node, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor:
memory coupled with the processor; and
instructions stored in the memory and executable by the processor to cause the apparatus to:
receive a first message indicating a first set of power control parameters associated with a first transmission reception point and a second set of power control parameters associated with a second transmission reception point, wherein at least the second set of power control parameters are associated with virtual power headroom reporting; and
transmit a second message comprising a first power headroom report and a second power headroom report, the first power headroom report generated by the UE for a first uplink transmission associated with a first reference signal resource index using the first set of power control parameters, and the second power headroom report generated by the UE for a reference uplink transmission associated with a second reference signal resource index using the second set of power control parameters.

2. The apparatus of claim 1, wherein the instructions are further executable by the processor to receive the first message by being executable by the processor to:
receive the first message indicating a transmission configuration indicator configuration identifying that the first uplink transmission is associated with a first transmission configuration indicator state and the reference uplink transmission is associated with a second transmission configuration indicator state.

3. The apparatus of claim 1, wherein the instructions are further executable by the processor to receive the first message by being executable by the processor to:
receive the first message indicating an uplink bandwidth part configuration identifying that the first uplink transmission is associated with the first set of power control parameters and that the reference uplink transmission is associated with the second set of power control parameters.

4. The apparatus of claim 1, wherein the instructions are further executable by the processor to receive the first message by being executable by the processor to:
receive the first message indicating a serving cell configuration identifying that the first uplink transmission is associated with the first set of power control parameters and that the reference uplink transmission is associated with the second set of power control parameters.

5. The apparatus of claim 1, wherein the first set of power control parameters and the second set of power control parameters comprise a pathloss reference signal parameter.

6. The apparatus of claim 5, wherein the first set of power control parameters and the second set of power control parameters further comprise a nominal power parameter, an alpha value parameter, and a close loop index parameter.

7. The apparatus of claim 6, wherein the first set of power control parameters and the second set of power control parameters further comprise a power management maximum power reduction parameter.

8. The apparatus of claim 1, wherein the first uplink transmission comprises an actual uplink transmission.

9. The apparatus of claim 1, wherein the first uplink transmission comprises a reference uplink transmission.

10. The apparatus of claim 1, wherein the first power headroom report and the second power headroom report are a first type of power headroom report that indicates a difference between a maximum transmit power of the UE and an estimated power of an uplink transmission.

11. The apparatus of claim 1, wherein the instructions are further executable by the processor to receive the first message by being executable by the processor to:
receive the first message according to a single frequency network configuration.

12. An apparatus for wireless communication at a network node, comprising:
a processor:
memory coupled with the processor; and
instructions stored in the memory and executable by the processor to cause the apparatus to:
transmit a first message indicating a first set of power control parameters associated with a first transmission reception point and a second set of power control parameters associated with a second transmission reception point, wherein at least the second set of power control parameters are associated with virtual power headroom reporting; and
receive a second message comprising a first power headroom report and a second power headroom report, the first power headroom report generated by a user equipment (UE) for a first uplink transmission associated with a first reference signal resource index using the first set of power control parameters, and the second power headroom report generated by the UE for a reference uplink transmission associated with a second reference signal resource index using the second set of power control parameters.

13. The apparatus of claim 12, wherein the instructions are further executable by the processor to transmit the first message by being executable by the processor to:
transmit the first message indicating a transmission configuration indicator configuration identifying that the first uplink transmission is associated with a first transmission configuration indicator state and the reference uplink transmission is associated with a second transmission configuration indicator state.

14. The apparatus of claim 12, wherein the instructions are further executable by the processor to transmit the first message by being executable by the processor to:
transmit the first message indicating an uplink bandwidth part configuration identifying that the first uplink transmission is associated with the first set of power control parameters and that the reference uplink transmission is associated with the second set of power control parameters.

15. The apparatus of claim 12, wherein the instructions are further executable by the processor to transmit the first message by being executable by the processor to:
transmit the first message indicating a serving cell configuration identifying that the first uplink transmission is associated with the first set of power control parameters and that the reference uplink transmission is associated with the second set of power control parameters.

16. The apparatus of claim 12, wherein the first set of power control parameters and the second set of power control parameters comprise a pathloss reference signal parameter.

17. The apparatus of claim 16, wherein the first set of power control parameters and the second set of power control parameters further comprise a nominal power parameter, an alpha value parameter, and a close loop index parameter.

18. The apparatus of claim 17, wherein the first set of power control parameters and the second set of power control parameters further comprise a power management maximum power reduction parameter.

19. The apparatus of claim 12, wherein the first uplink transmission comprises an actual uplink transmission.

20. The apparatus of claim 12, wherein the first uplink transmission comprises a reference uplink shared channel transmission.

21. The apparatus of claim 12, wherein the first power headroom report and the second power headroom report are a first type power headroom report that indicates a difference between a maximum transmit power of the UE and an estimated power of an uplink transmission.

22. The apparatus of claim 12, wherein the instructions are further executable by the processor to transmit the first message by being executable by the processor to:
receive the first message according to a single frequency network configuration.

23. A method for wireless communication at a user equipment (UE), comprising:
receiving a first message indicating a first set of power control parameters associated with a first transmission reception point and a second set of power control parameters associated with a second transmission reception point, wherein at least the second set of power control parameters are associated with virtual power headroom reporting; and
transmitting a second message comprising a first power headroom report and a second power headroom report, the first power headroom report generated by the UE for a first uplink transmission associated with a first reference signal resource index using the first set of power control parameters, and the second power headroom report generated by the UE for a reference uplink transmission associated with a second reference signal resource index using the second set of power control parameters.

24. The method of claim 23, wherein receiving the first message comprises:
receiving the first message indicating a transmission configuration indicator configuration identifying that the first uplink transmission is associated with a first transmission configuration indicator state and the reference uplink transmission is associated with a second transmission configuration indicator state.

25. The method of claim 23, wherein receiving the first message comprises:
receiving the first message indicating an uplink bandwidth part configuration identifying that the first uplink transmission is associated with the first set of power control parameters and that the reference uplink transmission is associated with the second set of power control parameters.

26. The method of claim 23, wherein receiving the first message comprises:
receiving the first message indicating a serving cell configuration identifying that the first uplink transmission is associated with the first set of power control parameters and that the reference uplink transmission is associated with the second set of power control parameters.

27. A method for wireless communication at a network node, comprising:
transmitting a first message indicating a first set of power control parameters associated with a first transmission reception point and a second set of power control parameters associated with a second transmission reception point, wherein at least the second set of power control parameters are associated with virtual power headroom reporting; and
receiving a second message comprising a first power headroom report and a second power headroom report, the first power headroom report generated by a user equipment (UE) for a first uplink transmission associated with a first reference signal resource index using the first set of power control parameters, and the second power headroom report generated by the UE for a reference uplink transmission associated with a second reference signal resource index using the second set of power control parameters.

28. The method of claim 27, wherein transmitting the first message comprises:
transmitting the first message indicating a transmission configuration indicator configuration identifying that the first uplink transmission is associated with a first transmission configuration indicator state and the reference uplink transmission is associated with a second transmission configuration indicator state.

29. The method of claim 27, wherein transmitting the first message comprises:
transmitting the first message indicating an uplink bandwidth part configuration identifying that the first uplink transmission is associated with the first set of power control parameters and that the reference uplink transmission is associated with the second set of power control parameters.

30. The method of claim 27, wherein transmitting the first message comprises:
transmitting the first message indicating a serving cell configuration identifying that the first uplink transmission is associated with the first set of power control parameters and that the reference uplink transmission is associated with the second set of power control parameters.
